(19) United States
(12) Patent Application Publication
(10) Pub. No.: US 2006/0036999 A1
(43) Pub. Date: Feb. 16, 2006

(54) System and method for managing test and measurement components

(76) Inventors: Thomas R. Fay, Fort Collins, CO (US); Kevin M. Cattell, North Vancouver (CA); Richard D. Warta JR., Santa Rosa, CA (US); Parameshwaran S. Kandasamy, Santa Rosa, CA (US); Jon Christopher Moens, Windsor, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/917,726

(22) Filed: Aug. 13, 2004

(51) Int. Cl. G06F 9/44

(52) U.S. Cl. 717/120

(57) ABSTRACT

A method and system for managing an instance of a software component for performing an operation. The system includes a state machine and an interface. The state machine can be created via a request for activation of the instance by an application. The interface specifies conditions under which the state machine and a user of the instance interact. The state machine has a plurality of states, has capability to construct and dynamically configure system resources needed by the instance, has capability to automatically transition between and through states as required, has capability to ensure that the instance is in correct condition when it enters a given state, and has capability to appropriately reconfigure the system resources prior to destruction of the instance.

### BACKGROUND

Modem test and measurement systems typically consist of various components. These components are generally software modules that are designed to perform specific measurements or sets of measurements. As needed by the system they are activated, perform their assigned tasks, and are then disposed of. The control of test and measurement components through-out their active lives, including any start-up and shutdown tasks is referred to as life-cycle management. Life-cycle management includes the overhead tasks of component creation and component setup, as well as performing its assigned tasks and then any clean-up and shut down processes. In other words, life-cycle management includes control of all aspects of the component from its creation to its disposal. Some mechanism is usually needed to prepare the components for the operations that they are to perform and then to clean up the system after the operations are finished. Traditionally, arranging for overhead functions to perform these setup and clean-up tasks has been left to the writer of that component. Leaving this responsibility fully in the hands of the component developer has resulted in the use of inconsistent mechanisms for this sort of overhead (life-cycle management). As such, the reusability of these components is limited. Further, if users of these components do not adhere to the conventions of each component, there is the risk that a component will not be correctly setup or shut down.

One means by which consistency could be assured is to build the life-cycle management into a base class of an object oriented program that all components used in the system build upon (inherit from). In generic component architectures like Microsoft's .NET framework, classes are permitted only one base class that they inherit from. This feature creates problems for users that wish to use base classes to standardize other aspects of their components. Another aspect of Microsoft .NET components is that they typically construct all the child objects they need in the initial constructor method for the class. However, to be a valid Microsoft .NET component, at least one form of the constructor must have no parameters, which means there is no opportunity to configure the component for the intended use, as might be the case with measurement components, where the exact instrument they are to control needs to be specified by the user of that component.

Current measurement component products such as National Instruments Measurement Studio provide limited aids for writing the construction aspects of those components, forcing the user of those components to understand and use the life-cycle model. Further, they do not break down the life-cycle of components to facilitate optimized usage of the components. Specialized languages like Agilent's VEE and National Instrument's LabView provide construction mechanisms that are not easily controlled or configured from outside those languages, and the resulting components are difficult to use with components built in other languages because LabView and VEE tend to manage their own instruments, making it difficult for components written in other languages to coordinate instrument use.

### SUMMARY

In a representative embodiment, a system for managing an instance of a software component for performing an operation are disclosed. The system includes a state machine and an interface. The state machine can be created via a request for activation of the instance by an application. The interface specifies conditions under which the state machine and a user of the instance interact. The state machine has a plurality of states, has capability to construct and dynamically configure system resources needed by the instance, has capability to automatically transition between and through states as required, has capability to ensure that the instance is in correct condition when it enters a given state, and has capability to appropriately reconfigure the system resources prior to destruction of the instance.

In another representative embodiment, a method for managing the instance of the software component for performing the operation are disclosed. The method includes requesting activation of the instance by an application, creating a state machine, and defining an interface. The interface specifies conditions under which the state machine and a user of the instance interact. When created the state machine has a plurality of states, has capability to construct and dynamically configure system resources needed by the instance, has capability to automatically transition between and through states as required, has capability to ensure that the instance is in correct condition when it enters a given state, and has capability to appropriately reconfigure the system resources prior to destruction of the instance.

Other aspects and advantages of the representative embodiments presented herein will become apparent from the following detailed description, taken in conjunction with the accompanying drawings.

### BRIEF DESCRIPTION OF THE DRAWINGS

The accompanying drawings provide visual representations which will be used to more fully describe various representative embodiments and can be used by those skilled in the art to better understand them and their inherent advantages. In these drawings, like reference numerals identify corresponding elements.

FIG. 1 is a block diagram of a measurement arrangement as described in various representative embodiments.

FIG. 2 is a block diagram of a component instance control system as described in various representative embodiments.

FIG. 3 is a block diagram of a component definition as described in various representative embodiments.

FIG. 4 is a block diagram of an interface definition as described in various representative embodiments.

FIG. 5 is a block diagram of a state machine as described in various representative embodiments.

FIG. 6 is a block diagram of another state machine as described in various representative embodiments.

FIG. 7 is a block diagram of still another state machine as described in various representative embodiments.

FIG. 8 is a flow chart of a method for managing an instance of a software component as described in various representative embodiments.

### DETAILED DESCRIPTION

As shown in the drawings for purposes of illustration, representative embodiments disclosed herein provide novel systems and methods to manage the life-cycle of a measurement component instance. These systems and methods include a standard defined interface and a state machine. The method does not interfere with the component developer's preferred structure for the measurement component in terms of its set of methods and properties by virtue of the fact that an interface rather than the class definition itself is used to define the life-cycle methods and properties that are associated with the measurement component. The disclosed method provides for an extensible state machine that is associated with present implementations of the life-cycle interface. This state machine allows for the automatic transitioning from one state to another state in order to perform the requested tasks. Further, the state machine will automatically transition through intervening states prior to attaining a specified state. For instance if a measurement component instance needs a child component to perform a particular measurement that has not been created, calling for that measurement automatically results in the creation of that child component and the measurement instance passing through states which assemble the child component and complete configuration tasks prior to performing the measurement. In addition, in representative embodiments invalid operations of the measurement component based on its state can be disallowed.

The state machine implementation of the life-cycle interface is extensible in that changes in allowed states and allowed transitions are easily effected. Such changes occur so that users of the component do not have to be aware of the life-cycle aspect, but simply use the measurement component. The interface is the mechanism used by the user of the component instance to control that instance.

Previous techniques for control of the life-cycle of a test and measurement component have not provided this uniformity and control, nor have they provided for the automatic transitioning from a given state through intervening states to arrive at the correct state for a particular operation provided by the measurement component.

In the following detailed description and in the several figures of the drawings, like elements are identified with like reference numerals.

Characteristics of representative embodiments disclosed herein include: (1) an abstract life-cycle management interface definition that components can implement to advertise that they adhere to the conventions that interface implies without requiring a particular base class be used, (2) a base class containing an extensible state machine which automatically manages the life-cycle of the component, (3) base classes which use an equipment manager to obtain instrument driver objects to make them externally configurable, (4) more reusable measurements due to the component being configurable via an external equipment configuration store utilized by an equipment manager to provide instrument driver objects by name, (5) more reusable tests because creation of child measurement components are isolated in a component manager so the tests are more loosely coupled to those components and users of these tests can configure where and which child components are supplied to the test, (6) late construction of the component which enables configuration before construction of the component, (7) management of setup and cleanup processes for measurement and test components which enables an increased speed of operation, and (8) components which can be written in a variety of languages and used in applications written in the same or a different language.

Advantages of the disclosed representative embodiments include items as follows:

First, users of components don't have to address considerations of the life-cycle of the components. Users can begin using the components immediately as the life-cycle management state machine ensures they are in the correct state on first use. They don't have to worry about the connection to the instrument or the initialization of that instrument to have the measurement work correctly. Similarly, they don't have to worry about correct instrument shutdown after the measurement occurs;

Second, advanced users can configure the components after initially creating them to control the construction details of the component. For example, a user might create a measurement component, then set a property of that component to indicate which instrument that component should control. Thereafter, the component will use the correct driver object associated with the instrument.

Third, users can optimize speed of operation by executing the measurement repeatedly without redundant setup of the instrument involved, deferring instrument cleanup until all similar measurements are complete.

And fourth, component reuse is increased because the test and measurement components in representative embodiments can (a) self-manage their life-cycle without the knowledge of the component user, (b) provide a standardized way that components manage their life-cycle so that advanced users can configure and control them more easily, (c) obtain instrument driver objects by name from a configurable equipment manager, and (d) obtain other child components from a configurable component manager.

In representative embodiments, a standard system and method for managing the life-cycle of a measurement component instance is disclosed. The system comprises the following items:

First, a standard interface definition that components can implement to indicate they adhere to the life-cycle management standard of a representative embodiment.

Second, a state machine implementation that allows for dynamically adding states, defining and facilitating valid state transitions to other states. Each state is a class that indicates what other states it can transition to and implementing methods to make those transitions, when necessary. The underlying state machine manages the list of allowable states, tracks the current state of the component, and utilizes the individual state classes to effect transitions from one state to another, including automatically transitioning across multiple states when requested to transition from the current state to a state more than one state away from the current one. As discussed in the following paragraphs, the implemented state machine has separate states for managing the life-cycle. These states facilitate (a) assembling the child objects (like instrument driver objects) of components (assemble state), (b) setting up the instruments those components use (Setup state), (c) performing the measurement or test operation (Running state), (d) cleaning up instruments after all measurement or test operations are complete (Cleanup state), (e) indicating that an operation is complete (Stopped state), (f) indicating that an operation is paused (Paused state), (g) indicating that an operation error occurred (Error state), and (h) deconstructing the component (Disposing state).

Third, an equipment manager that facilitates specifying by name the instrument and software to use for a particular measurement. This equipment manager (a) creates and manages driver objects for instruments, (b) abstracts to a name the choice of which driver, which instrument, and which driver configuration to use, making measurement code more independent of the specific driver and instrument it utilizes, (c) can be extended to new driver families by creating a new adapter for each new family of drivers, rather than forcing each driver to be wrapped in some standard driver interface, (d) can be extended via adapters to obtain and store configuration information from a variety of storage locations and formats (example: custom XML file, IVI configuration server, or custom database), (e) facilitates multithreaded test and measurement execution by centrally managing locking of instrument driver object resources, and (f) provides a name-based catalog of available instrument drivers and sessions that facilitates writing the code to obtain a named driver object.

Fourth, a component manager that facilitates configuring the child components used by test and measurement components. The component manager (a) creates child component objects based on the type required, obtained from local or remote sources, optionally created in a separate Microsoft .NET application domain, (b) manages loading of user assemblies (DLL's) to permit component object creation and component cataloging, (c) provides a name-based catalog of available components to facilitate writing the code to obtain a component object, and (d) can be extended to other sources of assemblies and components via adapters.

And fifth, measurement component and test component base classes that utilize the state machine to implement an auto-transitioning version of the life-cycle interface. These components also utilize the equipment manager to obtain instrument driver objects and the component manager to obtain child components so that measurement components are more reusable because they can be externally configured regarding these details.

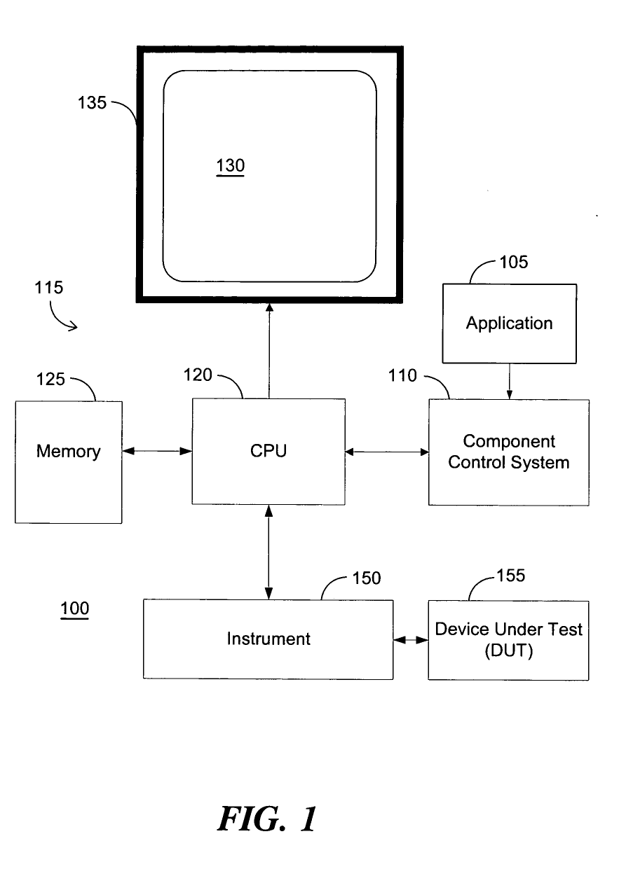

FIG. 1 is a block diagram of a measurement arrangement 100 as described in various representative embodiments. In FIG. 1, a computer 115 comprises a central processing unit (CPU) 120, a memory 125, and a monitor 135. In a representative embodiment of a test configuration, a software application 105, also referred to herein as an application 105, operating on the computer 115 communicates with an instrument 150 which performs measurements on a device under test (DUT) 155 under defined measurement conditions. This communication is effected by instances of software components operating on the computer 115 that are controlled by a component instance control system 110, also referred to herein as a system 110. The measurement results can be collected and stored in the memory 125. Various actions and aspects of the measurement process can be displayed via a graphical user interface or other means on a screen 130 of the monitor 135.

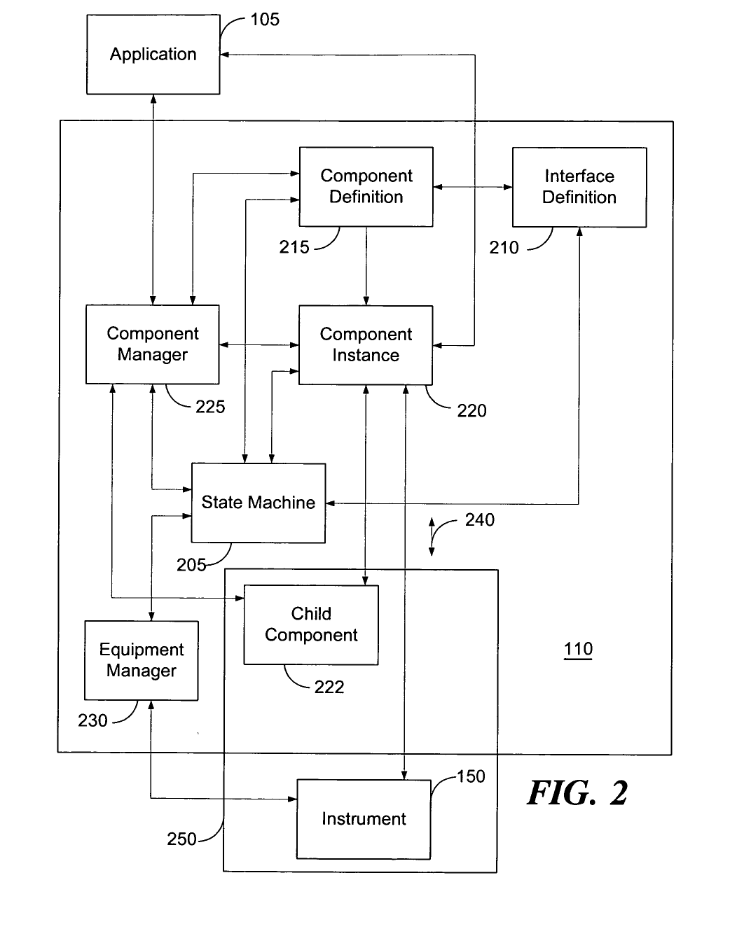

FIG. 2 is a block diagram of the component instance control system 110 as described in various representative embodiments. In the embodiment of FIG. 2, a state machine 205 uses a common interface definition 210, also referred to herein as an interface 210 and as an interface definition 210. This interface 210 is shared with and used by a software component definition 215, also referred to herein as a component definition 215, as a software component 215, and as a component 215. A component instance 220, also referred to herein as an instance 220, of the component definition 215 is created in compliance with the component definition 215 and association with the interface 210.

A component manager 225, shown in FIG. 2 communicating with the application 105, the component definition 215, the component instance 220, and the state machine 205 facilitates configuring the child components used by test and measurement components. As stated above, the component manager 225 (a) creates child component objects based on the type required, obtained from local or remote sources, optionally created in a separate Microsoft .NET application domain, (b) manages loading of user assemblies (DLL's) to permit component object creation and component cataloging, (c) provides a name-based catalog of available components to facilitate writing the code to obtain a component object, and (d) can be extended to other sources of assemblies and components via adapters.

An equipment manager 230, shown in FIG. 2 communicating with the state machine 205 and the instrument 150, facilitates specifying by name the instrument and software to use for a particular measurement. As stated above, this equipment manager 230 (a) creates and manages driver objects for instruments 150, (b) abstracts to a name the choice of which driver, which instrument 150, and which driver configuration to use, making measurement code more independent of the specific driver and instrument 150 it utilizes, (c) can be extended to new driver families by creating a new adapter for each new family of drivers, rather than forcing each driver to be wrapped in some standard driver interface, (d) can be extended via adapters to obtain and store configuration information from a variety of storage locations and formats (example: custom XML file, IVI configuration server, or custom database), (e) facilitates multithreaded test and measurement execution by centrally managing locking of instrument driver object resources, and (f) provides a name-based catalog of available instrument drivers and sessions that facilitates writing the code to obtain a named driver object.

FIG. 2 also includes system resources 250 which can comprise the instrument 150 and child components 222 both of which in various implementations maybe needed by the component instance 220. The component manager 225 is used by the component instance 220 to create child components 222 as needed by the component instance 220. The component manager 225 interacts with child components 222, and the equipment manager 230 interacts with the instrument 150. The component instance 220 also interacts with the instrument 150 and child components 222.

Also shown in FIG. 2 is an operation 240 that the instance 220 is designed and configured to perform on the instrument 150. Not shown in FIG. 2 are any necessary drivers, etc necessary to perform the assigned operation 240.

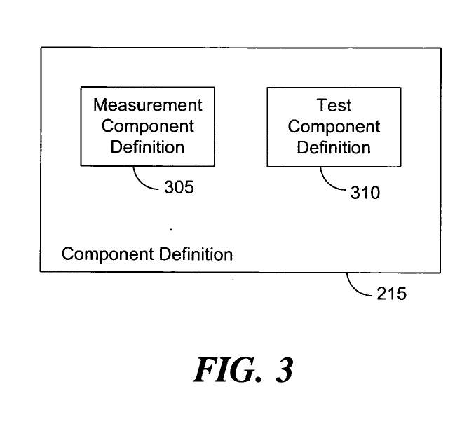

FIG. 3 is a block diagram of the component definition 215 as described in various representative embodiments. In FIG. 3, the component definition 215 is shown explicitly as comprising a measurement component definition 305 and a test component definition 310 distinction being made between the obtaining of the measured value of a parameter in association with the measurement component definition 305 and the obtaining of a decision based on test result criteria applied to a measured value, as for example pass or fail, in association with the test component definition 310.

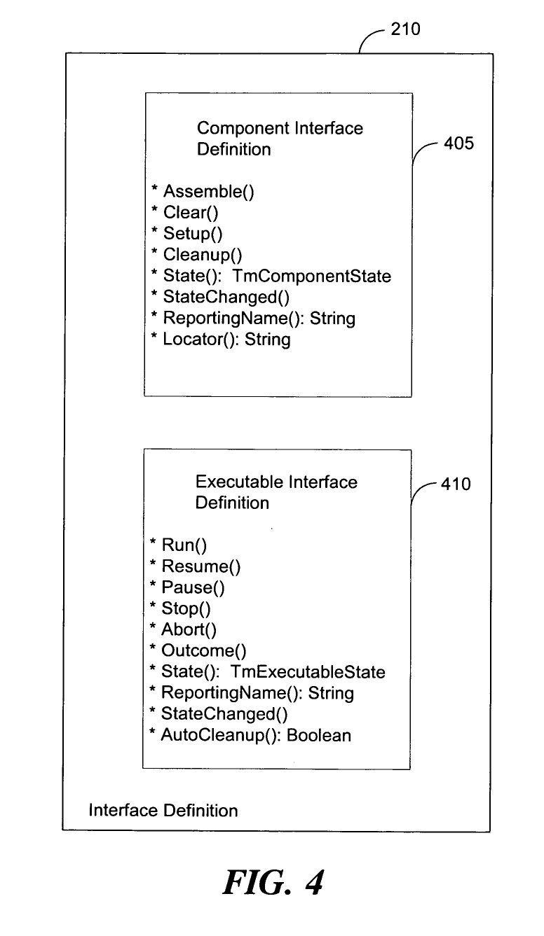

FIG. 4 is a block diagram of the interface definition 210 as described in various representative embodiments. In FIG. 4, the interface definition 210 comprises a component interface definition 405 and an executable interface definition 410. In the representative example of FIG. 4, the component interface definition 405 comprises prototype functions Assemble( ), Clear( ), Setup( ), Cleanup( ), State( ), ReportingName( ), and Locator( ). State( ) in the component interface definition 405 refers to the state of the instance 220 of the component 215. Both ReportingName( ) and Locator( ) return a string. Also, in the representative example of FIG. 4, the executable interface definition 410 comprises prototype functions Run( ), Resume( ), Pause( ), Stop( ), Abort( ), Outcome( ), State( ), ReportingName( ), StateChanged( ), and AutoCleanup( ). State( ) in the executable interface definition 410 refers to the executable state, ReportingName( ) returns a string, and AutoCleanup( ) returns or sets a boolean value. FIG. 4 is a representative example for illustrative purposes only. Other implementations may comprise definitions other than those shown in FIG. 4.

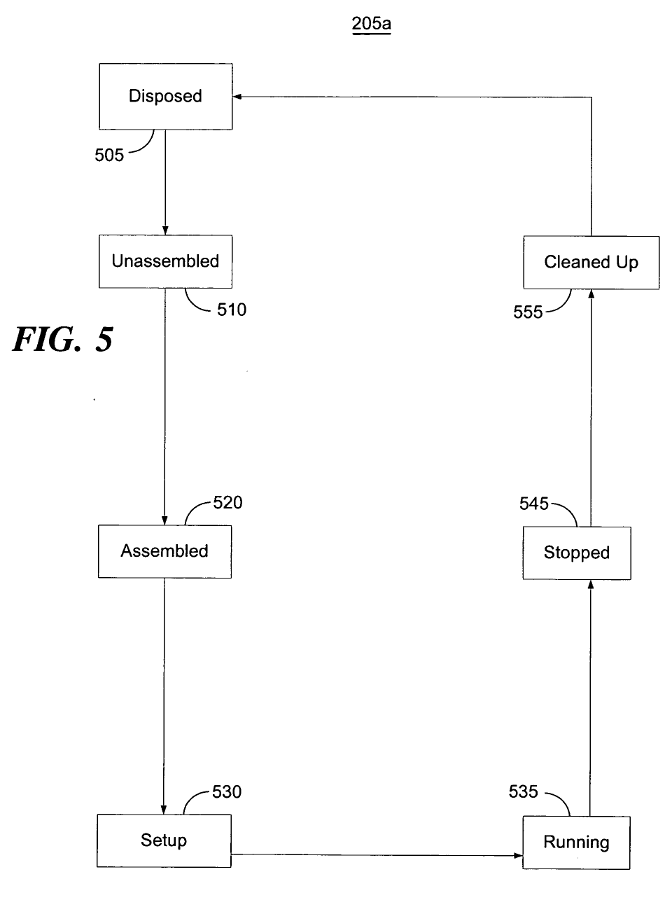

FIG. 5 is a block diagram of state machine 205a as described in various representative embodiments. The state machine 205a shown in FIG. 5 is a representative embodiment of the state machine 205 of FIG. 2, both of which for simplicity will be referred to as state machine 205 in the following discussion. In FIG. 5, a disposed condition 505 is not a part of the state machine 205 but is a representation of the condition in which the instance 220 and the state machine 205 itself do not exist. In the disposed condition 505, either they have never been created, or if created, they have been subsequently disposed of.

The state machine 205 and the interface 210 interact together to manage the instance 220 of the software component 215 for the purpose of performing an operation 240, as for example, a test or measurement operation. When a user of the component 215 uses interface 210 to interact with the component 215, the state machine 205 ensures the state of component 215 is appropriate for the requested operation, including automatically transitioning component 215 through multiple states if the method called on interface 210 requires a state different from the current state of component 215. The interface 210 specifies the mechanism under which users of the component 215 interact with the component 215. The implementation of interface 210 by component 215 utilizes the state machine 205 to ensure state-safe operation of component 215, i.e., that the component 215 is in the correct state when the user of the component 215 requests a particular operation.

The state machine 205 has a plurality of states which includes an unassembled state 510, also referred to herein as a start state 510, to which state the state machine 205 moves from the disposed condition 505 when the instance 220 is created.

The state of the state machine 205 moves from the unassembled state 510 to an assembled state 520 when information to configure the instance 220 and the information to select and acquire any needed system resources 250, including child components 222, driver instances, as well as other resources 250 becomes collected. System resource information could include, for example, the address of a memory device to be assigned for use by the instance 220 when created.

The state of the state machine 205 moves from the assembled state 520 to a setup state 530 when the instance 220 and any associated system resources become appropriately configured.

The state of the state machine 205 moves from the setup state 530 to a running state 535 when the instance 220 is used for its intended operation 240.

The state of the state machine 205 moves from the running state 535 to a stopped state 545 when performance of the operation 240 has been completed.

And, the state of the state machine 205 moves from the stopped state 545 to a cleaned up state 555 when appropriate condition modification of associated system resources 250 has been completed, wherein the instance 220 can become nonexistent, as indicated by the disposed condition 505 in FIG. 5, from the cleaned up state. Appropriate condition modification of associated system resources 250 could include the release of a dynamically assigned memory allocation, resetting of associated instrument resources, as well as other activities.

If when a request is made to perform the function of a particular state the component instance 220 is not in an adjacent state, the state machine 205 enables first transitioning automatically through any intervening states before reaching that particular state. For example, if the state of the instance 220 is not “setup” when the transition to “running” is requested by measurement component methods or the test component run( ) method but instead if the instance 220 is in the unassembled state 510, transition will first occur from the unassembled state 510 to the assembled state 520, then from the assembled state 520 to the setup state 530, and finally from the setup state 530 to the running state 535 in that order before the operation 240 associated with the run( ) method or measurement method can proceed. In this way, the user is assured that the instance 220 is always in the correct state prior to the performance of any function. The user is freed from activating the assemble and setup steps and only has to specify the desired measurement operation.

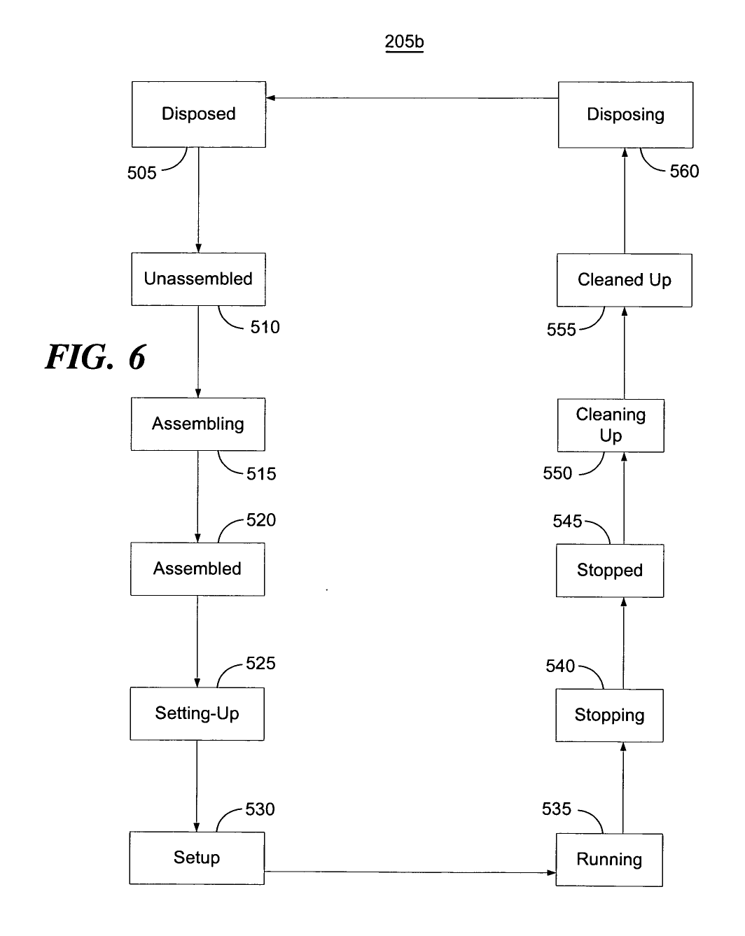

FIG. 6 is block diagram of another state machine 205b as described in various representative embodiments. The state machine 205b shown in FIG. 6 is a representative embodiment of the state machine 205 of FIG. 2, both of which for simplicity will be referred to as state machine 205 in the following discussion. In FIG. 6, the state machine 205 includes the disposed condition 505, the unassembled state 510, the assembled state 520, the setup state 530, the running state 535, the stopped state 545, and the cleaned up state 555 of FIG. 5. Also included in FIG. 6 are the transition states of an assembling state 515, a setting-up state 525, a stopping state 540, a cleaning up state 550, and a disposing state 560. These transition states allow the component 215 to perform additional operations before the operations associated with the states of FIG. 5 occur. In FIG. 5, the activities associated with these transition states were implicitly included in those shown in FIG. 5.

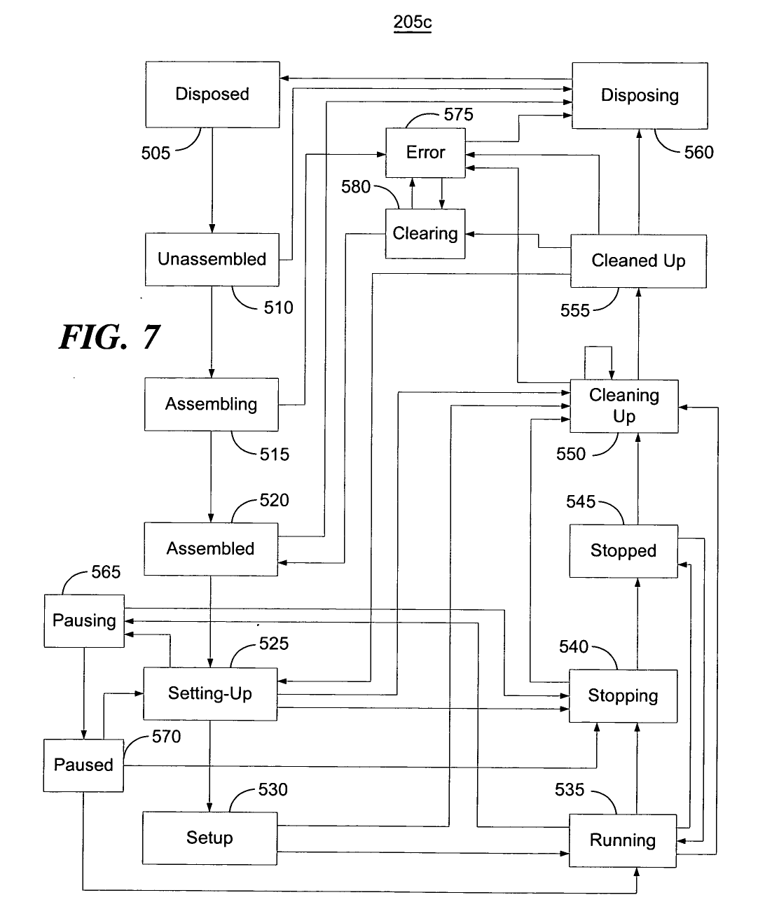

FIG. 7 is a block diagram of still another state machine 205c as described in various representative embodiments. The state machine 205c shown in FIG. 7 is a representative embodiment of the state machine 205 of FIG. 2, both of which for simplicity will be referred to as state machine 205 in the following discussion. In FIG. 7, the state machine 205 includes the disposed condition 505, the unassembled state 510, the assembling state 515, the assembled state 520, the setting-up state 525, the setup state 530, the running state 535, the stopping state 540, the stopped state 545, the cleaning up state 550, the cleaned up state 555, and the disposing state 560 of FIG. 6. Also included in FIG. 7 are the error handling capabilities indicated by an error state 575 and a clearing state 580. If an error is detected in, for example, the cleaning up state 550, the state is changed to the error state 575 which could invoke notification of the error to the user. The error state 575 then transitions to the clearing state 580 which clears error flags and returns the state of the instance to that of the assembled state 520.

Also shown in FIG. 7 are a pausing state 565 and a paused state 570. From the running state 535, for example, the state of the instance 220 could be put into the pausing state 565 from which it transitions into the paused state 570 prior to finally returning to the running state 535.

Other embodiments of the state machine 205 are also possible. In particular, the various additional paths, as for example, the transition from the assembling state 520 directly to the disposing state 560 is a transition which might not be found in other implementations. The various additional paths shown in FIG. 7 are for illustrative purposes.

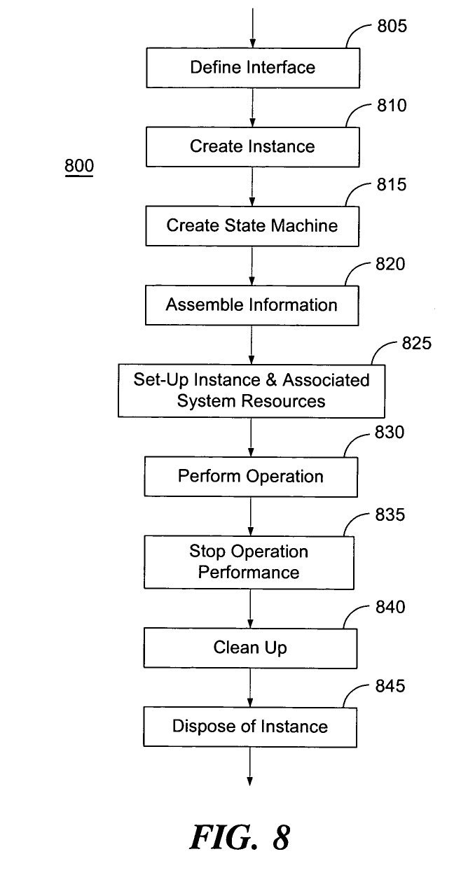

FIG. 8 is a flow chart of a method 800 for managing an instance 220 of a software component 215 as described in various representative embodiments. In block 805 of FIG. 8, the interface 210 specifying conditions under which the state machine 205 and the instances 220 interact is defined. Block 805 then transfers control to block 810.

In block 810, the instance 220 is created. Block 825 then transfers control to block 830.

In block 815, the state machine 205 associated with the instance 220 is created by the instance 220. The state machine 205 comprises the start state 510, the assembled state 520, the setup state 530, the running state 535, the stopped state 545, and the cleaned up state 555. When created, the state machine 205 is in the start state 510. Block 815 then transfers control to block 820.

In block 820, the information to configure the instance 220 and the information to select and acquire any needed system resources 250, including child components 222, driver instances, as well as other resources 250 is collected. The state machine 205 moves from the start state 510 to the assembled state 520 when such information has been used to acquire the resources 250 needed by the instance 220. Block 820 then transfers control to block 825.

In block 825, the instance 220 and any associated system resources are setup. The state machine 205 moves from the assembled state 520 to the setup state 530 when the instance 220 and any associated system resources have been appropriately configured. Block 825 then transfers control to block 830.

In block 830, the operation 240 is performed. Performance of the operation 240 could be done only once or many times depending upon system needs. Block 830 then transfers control to block 835.

In block 835 the running of the instance 220 is stopped. The state machine 205 moves from the running state 535 to the stopped state 545 when performance of any and all operations 240 are completed. Block 835 then transfers control to block 840.

In block 840, the associated system resources 250 are cleaned up. The state machine 205 moves to the cleaned up state 555 from the stopped state 545 when such modification has been completed. Block 840 then transfers control to block 845.

In block 845, the instance, as well as the state machine, are disposed of.

As is the case, in many data-processing products, the systems described above maybe implemented as a combination of hardware and software components. Moreover, the functionality required for use of the representative embodiments may be embodied in computer-readable media (such as floppy disks, conventional hard disks, DVD's, CD-ROM's, Flash ROM's, nonvolatile ROM, and RAM) to be used in programming an information-processing apparatus (e.g., the computer 115 comprising the elements shown in FIG. 1 among others) to perform in accordance with the techniques so described.

The term “program storage medium” is broadly defined herein to include any kind of computer memory such as, but not limited to, floppy disks, conventional hard disks, DVD's, CD-ROM's, Flash ROM's, nonvolatile ROM, and RAM.

The computer 115 can be capable of running one or more of any commercially available operating system such as DOS, various versions of Microsoft Windows (Windows 95, 98, Me, 2000, NT, XP, or the like), Apple's MAC OS X, UNIX, Linux, or other suitable operating system.

The representative embodiments can be advantageously implemented as an application program for a portable computer system. Such an application program can be written using a variety of programming languages and methodologies including Sun Microsystem's Java, Microsoft's Visual Basic, C/C++, Microsoft's C#, Microsoft's .NET assembler, or any other commercially-available programming tools.

Advantages of the disclosed representative embodiments include the following items: (14) users of components don't have to address considerations of the life-cycle of the components which includes considerations as to insuring that the system is in the correct state on first use (the state machine 205 automatically transitions through any intervening states before attaining the correct state), logical attachment to the instrument, initialization of the instrument, or correct instrument shutdown, (2) users can configure the components after initially creating them to control the construction details of the component, (3) users can optimize speed of operation by executing the measurement repeatedly without redundant setup of the instrument involved, deferring instrument cleanup until all similar measurements are complete, and (4) component reuse is increased.

Test and measurement components utilizing representative embodiments disclosed can (a) self-manage their life-cycle without the knowledge of the component user, (b) provide a standardized way that components manage their life-cycle so that advanced users can configure and control them more easily, (c) obtain instrument driver objects by name from a configurable equipment manager, and (d) obtain other child components from a configurable component manager.

The representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A method for managing an instance of a software component for performing an operation, comprising:
requesting activation of the instance by an application;
creating a state machine;
defining an interface specifying conditions under which the state machine and a user of the instance interact, wherein when created the state machine has a plurality of states, has capability to construct and dynamically configure system resources needed by the instance, has capability to automatically transition between and through states as required, has capability to ensure that the instance is in correct condition when it enters a given state, and has capability to appropriately reconfigure the system resources prior to destruction of the instance.

2. The method as recited in claim 1, wherein the state machine comprises a start state, an assembled state, a setup state, a running state, a stopped state, and a cleaned up state and wherein when created the state machine is in the start state, further comprising:
assembling the information to select any needed system resources, wherein the state machine moves from the start state to the assembled state when such information has been collected and system resources needed by the instance have been created;
setting up the instance and needed system resources, wherein the state machine moves from the assembled state to the setup state when the needed system resources have been appropriately configured;
running the operation, wherein the state machine moves from the setup state to the running state when the instance begins running the operation;
stopping the running of the instance, wherein the state machine moves from the running state to the stopped state when running the operation is finished; and
modifying condition of the needed system resources, wherein the state machine moves to the cleaned up state from the stopped state after appropriate modification of the condition of the needed system resources is finished.

3. The method as recited in claim 2, wherein the instance and the state machine can be disposed of from the cleaned up state.

4. The method as recited in claim 1, wherein the state machine is extensible.

5. The method as recited in claim 1, wherein the state machine is created and configured as part of an extensible base class.

6. The method as recited in claim 5, wherein the base class further comprises an equipment manager, wherein a function of the equipment manager has capability to obtain externally configurable information necessary for the instance to use an instrument.

7. The method as recited in claim 5, wherein the base class further comprises an externally configurable component manager, wherein a function of the component manager is used to create the instance of the software component and instance of a child software component needed by the parent instance.

8. The method as recited in claim 1, wherein the operation is a test and measurement operation.

9. A computer readable memory device embodying a computer program of instructions executable by a computer for managing an instance of a software component for performing an operation, the instructions comprising:
requesting activation of the instance by an application;
creating a state machine;
defining an interface specifying conditions under which the state machine and a user of the instance interact, wherein when created the state machine has a plurality of states, has capability to construct and dynamically configure system resources needed by the instance, has capability to automatically transition between and through states as required, has capability to ensure that the instance is in correct condition when it enters a given state, and has capability to appropriately reconfigure the system resources prior to destruction of the instance.

10. The computer readable memory device as recited in claim 9, wherein the state machine comprises a start state, an assembled state, a setup state, a running state, a stopped state, and a cleaned up state and wherein when created the state machine is in the start state, the instructions further comprising:
assembling the information to select needed system resources, wherein the state machine moves from the start state to the assembled state when such information has been collected and system resources needed by the instance have been created;
setting up the instance and needed system resources, wherein the state machine moves from the assembled state to the setup state when the needed system resources have been appropriately configured;
running the operation, wherein the state machine moves from the setup state to the running state when the instance begins running the operation;
stopping the running of the instance, wherein the state machine moves from the running state to the stopped state when running the operation is finished; and
modifying condition of the needed system resources, wherein the state machine moves to the cleaned up state from the stopped state after appropriate modification of the condition of the needed system resources is finished.

11. The computer readable memory device as recited in claim 10, wherein the instance and the state machine can be disposed of from the cleaned up state.

12. The computer readable memory device as recited in claim 9, wherein the state machine is extensible.

13. The computer readable memory device as recited in claim 9, wherein the state machine is created and configured as part of an extensible base class.

14. The computer readable memory device as recited in claim 13, wherein the base class further comprises an equipment manager, wherein a function of the equipment manager has capability to obtain externally configurable information necessary for the instance to use an instrument.

15. The computer readable memory device as recited in claim 13, wherein the base class further comprises an externally configurable component manager, wherein a function of the component manager is used to create the instance of the software component and instance of a child software component needed by the parent instance.

16. The computer readable memory device as recited in claim 9, wherein the operation is a test and measurement operation.

17. A system for managing an instance of a software component for performing an operation, comprising:
a state machine which can be created via a request for activation of the instance by an application; and
an interface specifying conditions under which the state machine and a user of the instance interact, wherein when created the state machine has a plurality of states, has capability to construct and to dynamically configure system resources needed by the instance, has capability to automatically transition between and through states as required, has capability to ensure that the instance is in correct condition when it enters a given state, and has capability to appropriately reconfigure the system resources prior to destruction of the instance.

18. The system as recited in claim 17, wherein the plurality of states comprises:
a start state to which the state machine moves when the state machine is created;
an assembled state to which the state machine moves from the start state after information to select the needed system resources has been collected and system resources needed by the instance have been created;
a setup state to which the state machine moves from the assembled state after the needed system resources have been appropriately configured;
a running state to which the state machine moves from the setup state when the instance is prepared to perform the operation;
a stopped state to which the state machine moves from the running state after completion of the operation has been completed; and
a cleaned up state to which the state machine moves from the stopped state after appropriate clean up of the condition of the needed system resources becomes complete.

19. The system as recited in claim 18, Wherein the instance and the state machine can be disposed of from the cleaned up state.

20. The system as recited in claim 17, wherein the state machine is extensible.

21. The system as recited in claim 17, wherein the state machine is created and configured as part of an extensible base class.

22. The system as recited in claim 21, wherein the base class further comprises an equipment manager, wherein a function of the equipment manager has capability to obtain externally configurable information necessary for the instance to use an instrument.

23. The system as recited in claim 21, wherein the base class further comprises an externally configurable component manager, wherein a function of the component manager is used to create the instance of the software component and instance of a child software component needed by the parent instance.

24. The system as recited in claim 17, wherein the operation is a test and measurement operation.
